(19) United States
(12) Patent Application Publication
(10) Pub. No.: US 2006/0013547 A1
(43) Pub. Date: Jan. 19, 2006

(54) Method for manufacturing optical waveguide, and optical waveguide made by the method

(75) Inventors: Hideki Kitano, Tokyo (JP); Takahiro Matsuse, Tokyo (JP); Masami Aoki, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION

(21) Appl. No.: 11/176,299

(22) Filed: Jul. 8, 2005

(30) Foreign Application Priority Data
Jul. 13, 2004 (JP) 205690/2004

(51) Int. Cl. G02B 6/02

(52) U.S. Cl. 385/124

(57) ABSTRACT

A method for manufacturing an optical waveguide including a core 1 and a cladding 2 that are integrally formed is provided. The method includes a masking step of masking a monolayer film 11 containing a photobleachable material by sandwiching the monolayer film 11 between a pair of masking members 12A and 12B, a first photoirradiation step of irradiating the monolayer film 11 with light from two opposing directions through the pair of masking members 12A and 12B, a removing step of removing the pair of masking members 12A and 12B from the monolayer film 11, and a second photoirradiation step of irradiating the monolayer film 11 after removing the masking members 12A and 12B with light from the two opposing directions.

### BACKGROUND OF THE INVENTION

1. Field of the Invention

The present invention relates to a method for manufacturing an optical waveguide and an optical waveguide produced thereby. In particular, the present invention relates to a method for manufacturing a graded-index (GI) type optical waveguide suitable for high-speed and large-capacity transmission and a GI-type optical waveguide produced thereby.

2. Description of the Related Art

With the recent progress in optical communication technology, high-performance optical waveguides have been developed as elementary components constituting optical communication devices such as optical switches and optical multi/demultiplexers. In general, the optical waveguides have a basic structure including a core and a cladding which are formed by forming a core layer on a substrate directly or through a lower cladding layer and then forming an upper cladding layer. The core layer is typically made of an inorganic material such as silica glass as in optical fibers because of its low optical propagation loss. Nowadays, polymer optical waveguides (film waveguides) made of organic materials such as synthetic resins, which have good processability and low costs, are investigated.

For example, plastic optical waveguides using polymethyl methacrylate (PMMA), polystyrene (PS), polycarbonate (PC), polyimide (PI), or the like are disclosed in Japanese Unexamined Patent Application Publication No. 6-347658. Furthermore, from the viewpoint of superior heat resistance, polymer optical waveguides using specific polyimide resins are extensively investigated (Japanese Unexamined Patent Application Publication No. 2001-108854).

Generally, two types of optical waveguides are available: a step-index (SI) type and a graded-index (GI) type. The SI-type optical waveguide has a core layer having a uniform refractive index. The GI-type optical waveguide has a distribution of the refractive index decreasing from the center of the core layer toward the cladding layer. The optical propagation time in the GI-type optical waveguides is constant, irrespective of optical pathways, so the optical propagation loss is low over a broad wavelength range. Therefore, the GI-type optical waveguides are suitable for high-speed and large-capacity transmission.

For example, Japanese Unexamined Patent Application Publication No. 2003-322742 discloses a GI-type optical waveguide having a refractive index distribution within a predetermined range. The GI-type optical waveguide is formed by permeating and dispersing a sublimating or volatile organic compound having a refractive index lower than that of a resin molded product from a surface of the resin molded product to a predetermined depth and the change of the refractive index of the optical waveguide part is defined by refractive indices of permeated and non-permeated resins. Such an optical waveguide is formed by putting the resin molded product and the organic compound under saturation vapor pressure so that the organic compound permeates and disperses from the surface to the inside of the resin molded product.

Technology relating to optical devices using a photobleachable material that changes its refractive index by light irradiation is also known. For example, Japanese Unexamined Patent Application Publication No. 9-178901 discloses an optical material with a refractive-index distribution continuously varying from the center toward the outside of the optical material and a method for manufacturing the optical material. The optical material is prepared by irradiating a material having atom groups capable of inducing photobleaching with light. The optical material can be applied to plastic optical fibers.

As mentioned above, the GI-type optical waveguides and the methods for manufacturing thereof are known, but a detailed investigation has not been conducted yet. In particular, the conventional methods have disadvantages such as a large number of steps, complicated processes, and difficulty in controlling of the refractive index. Therefore, it is desired to achieve a technology for readily and reliably producing GI-type optical waveguides having desired high performance by a manufacturing process that is simple and can readily control the refractive index.

### SUMMARY OF THE INVENTION

Accordingly, it is an object of the present invention to provide a method for manufacturing an optical waveguide, wherein the method is conducted by a simple process and can readily control a refractive index of the optical waveguide. Furthermore, it is an object of the present invention to provide a high-performance GI-type optical waveguide produced by the method.

The present inventors have conducted intensive studies to accomplish the above object, and as result of the studies, they have found that a desired refractive-index distribution can be formed by using a photobleachable material as an optical waveguide material and controlling the intensity of light irradiation on the photobleachable material with a masking member.

The present invention provides a method for manufacturing an optical waveguide having a core and a cladding that are integrally formed including: a masking step of masking a monolayer film containing a photobleachable material by sandwiching the monolayer film between a pair of masking members, a first photoirradiation step of irradiating the monolayer film with light from two opposing directions through the pair of masking members, a removing step of removing the pair of masking members from the monolayer film, and a second photoirradiation step of irradiating the monolayer film after removing the pair of masking members with light from the two opposing directions.

In the present invention, the monolayer film may be formed on a substrate and the masking step may be conducted by sandwiching the monolayer film and the substrate between the pair of masking members. Preferably, before the masking step, a surface, which comes into contact with the monolayer film, of at least one of the pair of masking members is treated with a releasing agent for easier removal in the removing step. The pair of masking members are preferably patterning masks having patterns corresponding to the core or graded masks having light transmissivity continuously varied corresponding to the core. Photoirradiation-induced change of the refractive index in the photobleachable material is preferably 0.001 or more.

The optical waveguide of the present invention is produced according to the method of the present invention described above. The core of the optical waveguide has a substantially circular cross section and a refractive index continuously increasing toward the center of the core.

According to the present invention, the optical waveguide can be readily manufactured by a simple process while the refractive index is adequately controlled. Therefore, a high-performance GI-type optical waveguide suitable for high-speed and large-capacity transmission can be readily and reliably obtained. As described above, a technology relating to a GI-type optical fiber using a photobleachable material is already disclosed in Japanese Unexamined Patent Application Publication No. 9-178901. However, the technology disclosed in this Patent document requires strictly defining photobleaching conditions such as a wavelength and intensity of light, an irradiation time, a region to be irradiated, and temperature, so the process is disadvantageously complicated. Furthermore, this Patent document does not make any suggestion about the application of the technology to a GI-type optical waveguide.

### BRIEF DESCRIPTION OF THE DRAWINGS

FIG. 1 is schematic explanatory diagrams illustrating a manufacturing process of an optical waveguide according to a first embodiment of the present invention.

FIG. 2 is schematic explanatory diagrams illustrating a manufacturing process of an optical waveguide according to a second embodiment of the present invention.

FIG. 3 is schematic explanatory diagrams illustrating a manufacturing process of an optical waveguide according to a third embodiment of the present invention.

### DESCRIPTION OF THE PREFERRED EMBODIMENTS

Embodiments according to the present invention will now be described in detail with reference to the accompanying drawings. The present invention relates to a method for manufacturing an optical waveguide including a core and a cladding that are integrally formed. In particular, the present invention relates to an improvement in a photoirradiation process for forming the core and the cladding in a monolayer film containing a photobleachable material.

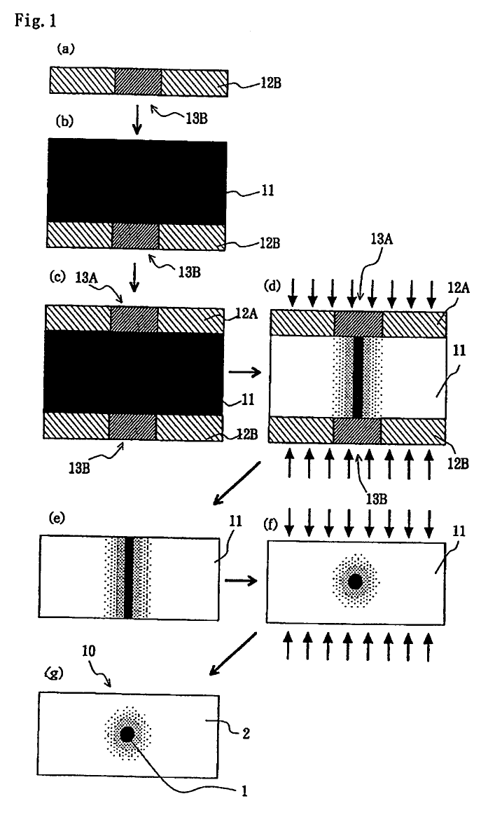

FIG. 1 shows schematic explanatory diagrams illustrating a manufacturing process of an optical waveguide according to a first embodiment of the present invention. With reference to FIG. 1, the manufacturing process according to the present invention includes: a masking step (a) to (c) of masking a monolayer film 11 containing a photobleachable material by sandwiching the monolayer film 11 between a pair of masking members 12A and 12B, a first photoirradiation step (d) of irradiating the monolayer film 11 with light from two opposing directions through the pair of masking members 12A and 12B, a removing step (e) of removing the pair of masking members 12A and 12B from the monolayer film 11, and a second photoirradiation step (f) of irradiating the monolayer film 11 after removing the pair of masking members 12A and 12B with light from the two opposing directions. According to this process, the optical waveguide 10 including a core 1 and a cladding 2 as shown by (g) can be obtained by a simple process compared with conventional methods.

In the masking step indicated by (a) to (c), the masking member 12B is used as a substrate (a). The monolayer film 11 is formed on the masking member 12B by coating a monolayer film material including the photobleachable material (b). Then, the masking member 12A is laminated on the resulting monolayer film 11 (c). Thus, the monolayer film 11 is sandwiched between the pair of masking members 12A and 12B. The pair of masking members 12A and 12B have patterns 13A and 13B, respectively, corresponding to the core 1. Therefore, the masking members 12A and 12B must be aligned so that the patterns 13A and 13B oppose each other with the monolayer film 11 therebetween.

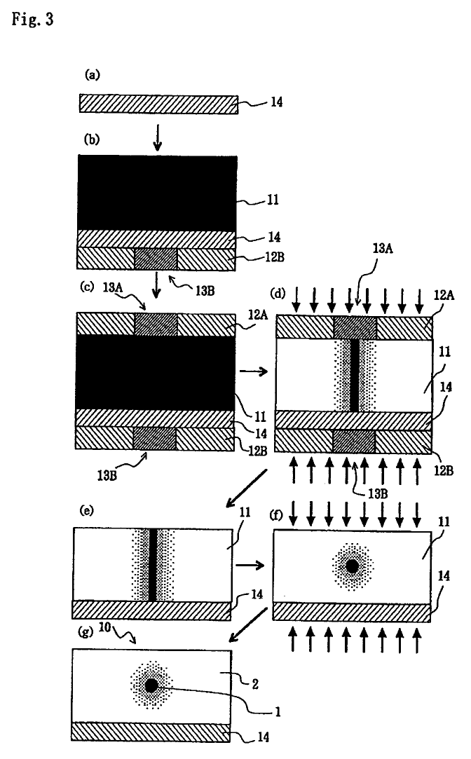

The masking step according to the present invention is not limited to the manner shown in FIG. 1. As shown in FIG. 3, the monolayer film 11 may be coated on a substrate 14 of glass or the like and then be masked by laminating the masking members 12A and 12B so that the monolayer film 11 and the substrate 14 are sandwiched between the pair of masking members 12A and 12B. In such a component, since the photoirradiation of the monolayer film 11 is performed through the substrate 14, the substrate 14 must have a transmissivity of more than 30% for light having a wavelength necessary for changing the refractive index of the photobleachable material. In this case, an optical waveguide 10 formed on the substrate 14 is obtained as shown by (g) in FIG. 3.

In each manner mentioned above, the positional relation between the monolayer film 11 and the masking members 12A and 12B must be maintained during the photoirradiation, but the masking members 12A and 12B are not necessarily fixed on the monolayer film 11. The masking members 12A and 12B may be disposed on the monolayer film 11 with or without a gap. When the masking member comes into contact with the monolayer film 11, such as in a case that the masking member is used as a substrate, it is preferable that the surface, which comes into contact with the monolayer film 11, of the masking member be previously treated with a releasing agent for easier removal in the removing step. With this treatment, the masking members can be readily removed in the removing step (e). The means for forming the monolayer film 11 on the substrate or on the masking member is not limited; for example, a material for the monolayer film 11 is coated by a general method such as spin-coating, coil-bar coating, or micro-gravure coating, and then is heat dried for curing.

In the first photoirradiation step (d), a refractive-index distribution corresponding to the patterns is formed in the width direction of the monolayer film 11 as shown in the drawings by irradiating the monolayer film 11 with light through the masking members 12A and 12B. As shown in the drawings, the light passing through the masking members 12A and 12B enters the inner side of the width of the patterns corresponding to the core 1 by diffraction. Therefore, in the core portion, the photoirradiation intensity increases to both ends in the width direction of the monolayer film 11 with a decrease in the refractive index. The photoirradiation intensity decreases toward the center of the core portion, consequently, a change in the refractive index is reduced. As a result, the central region of the core portion has a refractive index higher than that of both ends. Thus, a cladding portion is formed at both sides in the width direction of the monolayer film 11 and a continuous refractive-index gradient is formed at the central region in the width direction of the monolayer film 11.

In the removing step (e), the pair of masking members 12A and 12B are removed from the monolayer film 11. Then, the monolayer film 11 is irradiated with light again from the two opposing directions in the second photoirradiation step (f). As a result, a refractive-index distribution is formed in the height direction of the monolayer film 11. In this case as shown in the drawings, by the photoirradiation from the upper and lower sides of the monolayer film 11, the irradiation intensity increases to the top and bottom surfaces and decreases toward the center in the height direction. Therefore, a cladding portion is formed in the vicinity of the top and bottom surfaces and a refractive-index gradient is formed at the central region in the height direction, as in the width direction. Thus, as shown in drawings, an optical waveguide 10 including the core 1 having a substantially circular cross section and a refractive index continuously increasing toward the central region and the cladding 2 surrounding the core 1 can be prepared. The photoirradiation intensity in the first photoirradiation step (d) and the second photoirradiation step (f) is suitably determined depending on, but not limited to, a thickness and material of the monolayer film 11, a desired size of the core 1, and the like.

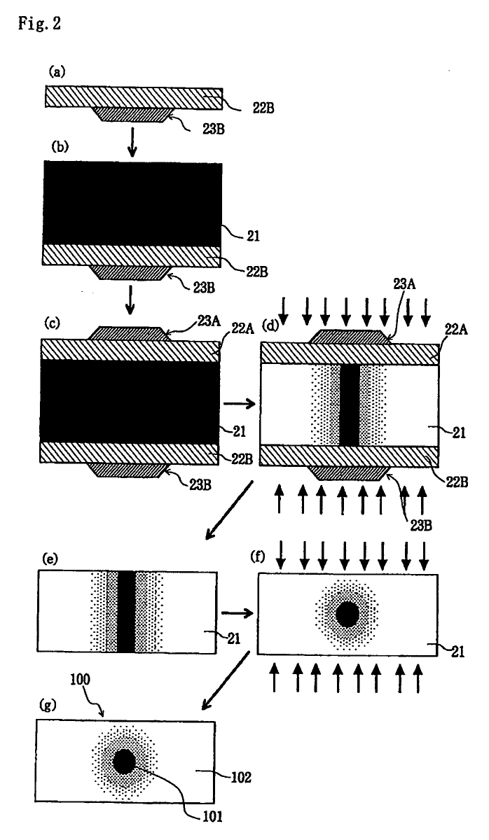

In the present invention, as shown in FIG. 2, graded masks (or called half masks) 22A and 22B of which transmissivity of light is continuously varied corresponding to a core 101 may be used as the masking members. The pair of masking members 22A and 22B have patterns 23A and 23B, respectively, corresponding to the core 101. In such a case, the irradiation intensity of the light passing through the graded mask members 22A and 22B in the first photoirradiation step (d) changes with a gradient corresponding to the transmissivity distribution of the graded mask members 22A and 22B. Consequently, a gradient in refractive-index distribution is formed in the width direction of a monolayer film 21 corresponding to the intensity of the light passing through the graded mask members 22A and 22B. As a result, a desired size and refractive-index distribution of the core 101 can be readily prepared. The process shown in FIG. 2 can be conducted as in the process shown in FIG. 1, except that the graded mask members 22A and 22B are used. Thus, an optical waveguide 100 having the core 101 and a cladding 102 can be prepared.

The monolayer film 11 (21) used in the present invention must contain a photobleachable material, i.e. a material changing its refractive-index by photoirradiation. With the photobleachable material, the core 1 (101) and the cladding 2 (102) can be formed by changing a refractive index in the monolayer film 11 (21). Any known photobleachable material can be used without limitation. Polysilane is a typical photobleachable material. In the present invention, a photobleachable material that changes its refractive-index by 0.001 or more by photoirradiation is preferably used to yield a sufficient differential refractive-index between the core 1 (101) and the cladding 2 (102). The monolayer film 11 (21) has a thickness enough for forming a structure composed of the core 1 (101) and the cladding 2 (102) as shown in the drawings, preferably, a thickness of 10 μm or more.

Any material can be used as the monolayer film 11 (21). Namely, the monolayer film 11 (21) may be formed by a photobleachable material alone or be formed by a combination of a photobleachable material and other material. The other material in the combination can be properly selected from the materials commonly used for cores or claddings in this field.

Examples of the other materials in the combination include acrylic, epoxy, polysilane, and polyimide resin materials and deuterides or fluorinated derivatives thereof. In particular, polymethyl methacrylate (PMMA), which is superior in transparency, is preferable. These resin materials poorly absorb light having a wavelength of 1.3 μm to 1.55 μm. Therefore, optical devices having reduced optical propagation loss can be prepared by the use of these materials.

In addition to quarts and glass, any material that has a transmissivity more than 30% for the light having a wavelength corresponding to the photobleachable material and does not deteriorate during a drying process can be used without limitation as the substrate of the present invention. Examples of such materials include a polyethylene terephthalate (PET) film, an acrylic resin film, a polycarbonate (PC) film, a triacetyl cellulose (TAC) film, and a polyimide (PI) film.

A surface of the optical waveguide 10 (100) according to the present invention may be coated with a hard-coat layer or a moisture-barrier layer. The core 1 (101) functions as a path for light to transmit information in the optical waveguide 10 (100), therefore, the core 1 (101) must be protected from being damaged. In order to avoid such damage as the performance of the optical waveguide decreases, the hard-coat layer may have to coat the surface of the optical waveguide 10 (100). Examples of the materials for the hard-coat layer include (meth)acrylate-based and epoxy-based hard-coatings which are prepared by polymerizing (meth)acrylate monomers such as monofunctional (meth)acrylates, bifunctional (meth)acrylates, and tri- or more-functional (meth)acrylates, polyfunctional epoxies, (meth)acrylic oligomers, urethane (meth)acrylates, epoxy (meth)acrylates, polyester (meth)acrylates, (meth)acrylate copolymers, or epoxy oligomers with photoinitiators; silicone-based hard-coatings (which may be treated with a primer coat) containing silane compounds, organometallic compounds, inorganic oxides microparticles, curing catalysts, or other materials, if necessary; inorganic hard-coatings such as organoalkoxysilane, alkoxysilane-zirconate, aqueous silicate, or aqueous alumina coatings, organoalkoxysilane-resin hybrids, alkoxysilane-zirconate-resin hybrids, and aqueous silicate-resin hybrids; and organic-inorganic hybrid hard-coatings such as cationic photocuring organic-inorganic hybrids.

Some materials used for the optical waveguide change their refractive indices by moisture absorption, so the refractive Indices largely deviate from the desired values. In order to prevent this, the moisture barrier is provided. The moisture-barrier layer is generally made of a highly hydrophobic material. Examples of the hydrophobic materials include water-repellent paint and compounds containing fluorine. Compounds containing silicon, such as SiO₂ and SiN₄, can be also used. These hydrophobic materials are applied on the top and bottom of the optical waveguide (film). This prevents the optical waveguide from absorbing moisture. When the moisture-barrier layer is provided on only one surface of the optical waveguide, anisotropy may occur to cause a warp.

Solvents for preparing coating solutions of each layer are properly selected from, but not limited to, the organic solvents that are commonly used. Examples of the solvents include acetone, methyl ethyl ketone (MEK), ethyl acetate, cellosolve acetate, dioxane, tetrahydrofuran (THF), benzene, and cyclohexanone.

### EXAMPLE

The present invention will now be specifically described with reference to an Example.

### Example

A glass plate (masking member 12B) including a pattern corresponding to a configuration of a core having a line width of 50 μm was used as a substrate. One surface of the substrate was coated with OPTOOL DSX (Daikin Industries, Ltd.). A photobleachable material (Glasia WG-106N: Nippon Paint Co., Ltd.) was coated on the substrate surface treated with OPTOOL DSX at a thickness of 70 μm by spin-coating, then pre-baking at 130° C. for 30 minutes was performed to form a monolayer film 11.

Then, a masking member 12A including the same pattern as that of the substrate (masking member 12B) was treated with OPTOOL DSX by the same manner as the above, and then was pasted on the monolayer film 11 so that the pattern of the masking member 12A corresponds to that of the substrate (masking member 12B). The monolayer film 11 was irradiated with UV light from the upper and lower sides through the masking member 12A and the substrate (masking member 12B) at a cumulative light dose of 15 J/cm². Then, the substrate (masking member 12B) and the masking member 12A were removed from the monolayer film 11. Furthermore, both surfaces of the resulting monolayer film 11 were irradiated with UV light at a cumulative light dose of 10 J/cm². Then, the monolayer film 11 was post-baked at 300° C. for 60 minutes to obtain the optical waveguide 10 including a core having a width of about 48 μm.

The cross section of the resulting optical waveguide 10 was observed to measure refractive indices with a two-beam microscope. The refractive index at the center of the core was 1.585, and that of the cladding was 1.577. The refractive index at the interface between the core and the cladding continuously changed to form a gradient of refractive index distribution. This proves that a GI-type optical waveguide can be readily and reliably manufactured according to the present invention.

What is claimed is:

1. A method for manufacturing an optical waveguide with a core and a cladding that are integrally formed, the method comprising:
a masking step of masking a monolayer film containing a photobleachable material by sandwiching the monolayer film between a pair of masking members, a first photoirradiation step of irradiating the monolayer film with light from two opposing directions through the pair of masking members, a removing step of removing the pair of masking members from the monolayer film, and a second photoirradiation step of irradiating the monolayer film after removing the pair of masking members with light from the two opposing directions.

2. The method for manufacturing an optical waveguide according to claim 1, wherein the masking step includes forming the monolayer film on a substrate and sandwiching the monolayer film and the substrate between the pair of masking members.

3. The method for manufacturing an optical waveguide according to claim 1, wherein a surface of at least one of the pair of masking members, the surface being in contact with the monolayer film, is treated with a releasing agent, before the masking step.

4. The method for manufacturing an optical waveguide according to claim 1, wherein the pair of masking members are patterning masks having patterns corresponding to the core.

5. The method for manufacturing an optical waveguide according to claim 1, wherein the pair of masking members are graded masks having transmissivity of light continuously varied corresponding to the core.

6. The method for manufacturing an optical waveguide according to claim 1, wherein a change in the refractive-index of the photobleachable material by photoirradiation is 0.001 or more.

7. An optical waveguide manufactured by the method according to claim 1, wherein the core has a substantially circular cross section and a refractive index continuously increasing toward the center.
